(19) United States
(12) Patent Application Publication
(10) Pub. No.: US 2020/0005137 A1
(43) Pub. Date: Jan. 2, 2020

(54) OUTPUT DEVICE, OUTPUT METHOD, AND NON-TRANSITORY COMPUTER READABLE STORAGE MEDIUM

(71) Applicant: YAHOO JAPAN CORPORATION, Tokyo (JP)

(72) Inventor: Hayato KOBAYASHI, Tokyo (JP)

(73) Assignee: YAHOO JAPAN CORPORATION, Tokyo (JP)

(21) Appl. No.: 16/237,840

(22) Filed: Jan. 2, 2019

(30) Foreign Application Priority Data
Jun. 27, 2018 (JP) 2018-122446

(51) Int. Cl. G06N 3/08; G06N 7/00; G06F 3/0482

(52) U.S. Cl. CPC G06N 3/08; G06F 3/0482; G06N 7/005

(57) ABSTRACT

An output device includes an acquiring unit that acquires a plurality of pieces of output information generated from predetermined target information by a plurality of models each of which generates, from input information, output information that includes a plurality of pieces of information having an order relation. The output device includes a selecting unit that selects, based on a similarity between the plurality of pieces of output information, from among the plurality of pieces of output information, output information that is to be output as association information associated with the target information. The output device includes an output unit that outputs, as the association information, the output information selected by the selecting unit.

### CROSS-REFERENCE TO RELATED APPLICATIONS

The present application claims priority to and incorporates by reference the entire contents of Japanese Patent Application No. 2018-122446 filed in Japan on Jun. 27, 2018.

### BACKGROUND OF THE INVENTION

### 1. Field of the Invention

The present invention relates to an output device, an output method, and a non-transitory computer readable storage medium.

### 2. Description of the Related Art

Conventionally, there is a known technology for generating output information associated with input information by using various kinds of models. As an example of this technology, there is a known technology for generating information that becomes a summary of the content from texts or images included in the input content.

Patent Literature 1: Japanese Laid-open Patent Publication No. 2018-073199

Here, there is a known technology for using an ensemble method in which, when information associated with input information is generated, a plurality of generation results is used in order to increase the accuracy of generating information. As the technology for using the ensemble method, there is a known technology for generating a plurality of models that sequentially outputs, when words constituting a sentence are sequentially input, an occurrence probability of the words constituting a summary or a heading in the order in which the words are included in the summary or the heading; averaging, in units of words, the occurrence probability that has been output by each of the models; and sequentially determining, based on the average value, each of the words constituting the summary or the heading.

However, in the conventional technology described above, there may be a case in which the output information associated with the input information is not always efficiently generated.

For example, it is conceivable to use a method of using a recurrent neural network (RNN) as a model when a summary or a heading is generated from a sentence. If this type of RNN is used as a model, it is conceivable to use a method for again inputting the word that was output by a model last time to the model as a new input and estimating a word that appears next time. However, if this type of RNN is combined with a conventional ensemble, there is a need to input the words determined based on the output from each of the models last time to all of the models every time a word is estimated and wait until all of the models has calculated the occurrence probability of the subsequent word. Furthermore, the same problem may possibly occur in, in addition to the process of outputting a summary or a heading from a sentence, a process of generating other pieces of information having sequential order from pieces of information having sequential order, such as music or a moving image.

### SUMMARY OF THE INVENTION

It is an object of the present invention to at least partially solve the problems in the conventional technology.

According to one aspect of an embodiment an output device includes an acquiring unit that acquires a plurality of pieces of output information generated from predetermined target information by a plurality of models each of which generates, from input information, output information that includes a plurality of pieces of information having an order relation. The output device includes a selecting unit that selects, based on a similarity between the plurality of pieces of output information, from among the plurality of pieces of output information, output information that is to be output as association information associated with the target information. The output device includes an output unit that outputs, as the association information, the output information selected by the selecting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a process performed by an information providing device according to an embodiment;

FIG. 2 is a diagram illustrating an example of a model generated by the information providing device according to the embodiment;

FIG. 3 is a diagram illustrating a configuration example of the information providing device according to the embodiment;

FIG. 4 is a diagram illustrating an example of information registered in a learning data database according to the embodiment;

FIG. 5 is a diagram illustrating an example of information registered in a learning data database according to the embodiment;

FIG. 6 is a flowchart illustrating an example of the flow of an output process performed by the information providing device according to the embodiment; and

FIG. 7 is a diagram illustrating an example of a hardware configuration.

### DETAILED DESCRIPTION OF THE PREFERRED EMBODIMENTS

A mode (hereinafter, referred to as an “embodiment”) for carrying out an output device, an output method, and a non-transitory computer readable storage medium according to the present application will be described in detail below with reference to the accompanying drawings. The output device, the output method, and the non-transitory computer readable storage medium are not limited to the embodiment. Furthermore, each of the embodiments can be appropriately used in combination as long as the content of processes does not conflict with each other. Furthermore, in the embodiments below, the same components are denoted by the same reference numerals and overlapping descriptions will be omitted.

### Embodiment

### 1. Outline of an Information Providing Device

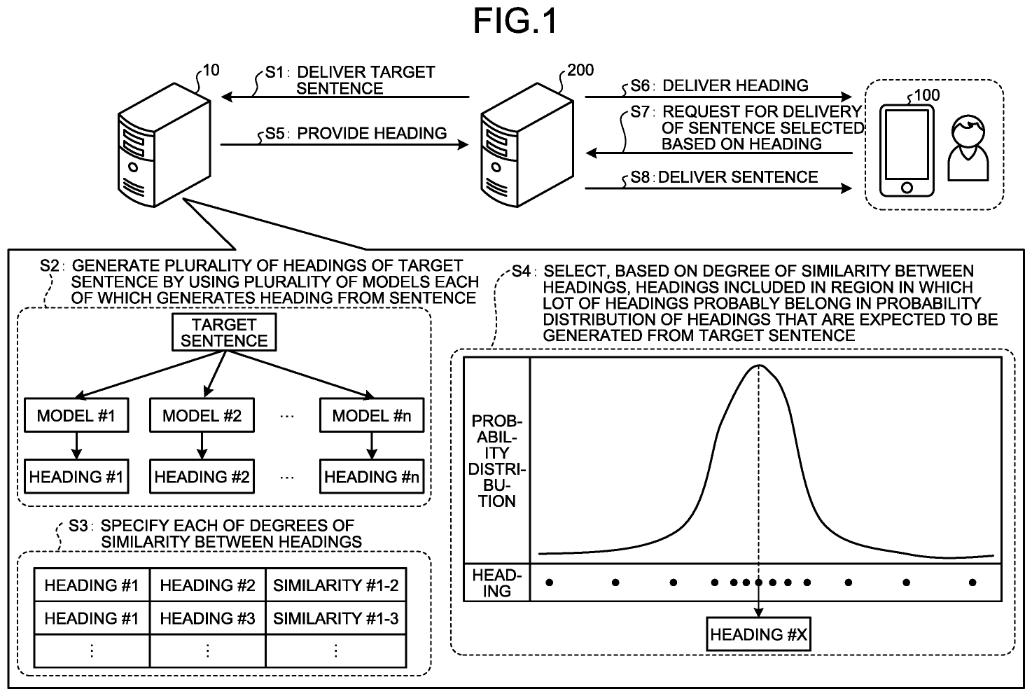

First, an example of a process performed by an information providing device that is an example of an output device will be described with reference to FIG. 1. FIG. 1 is a diagram illustrating an example of the process performed by the information providing device according to the embodiment. In FIG. 1, an information providing device 10 is an information processing device that performs an output process described below and is implemented by, for example, a server device, a cloud system, or the like.

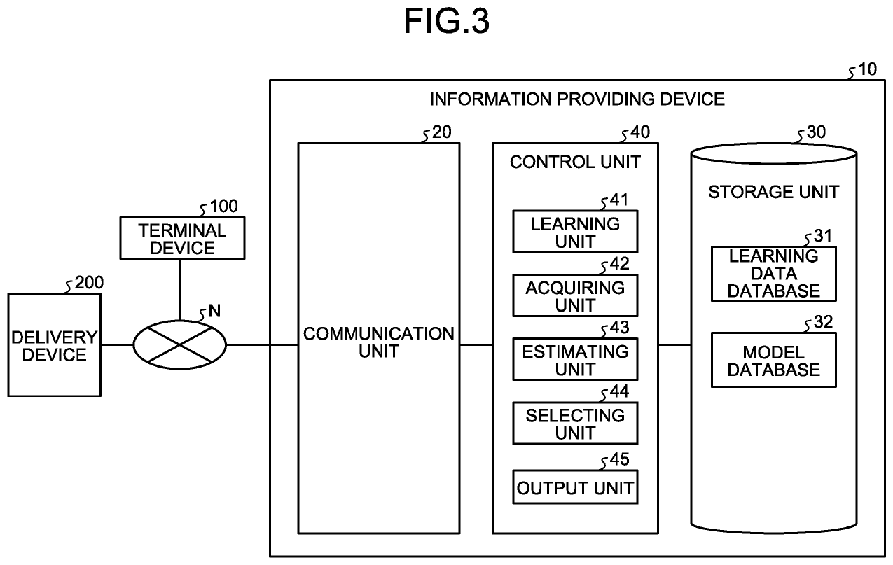

For example, the information providing device 10 can perform communication with a terminal device 100 and a delivery device 200 via a predetermined network N (for example, see FIG. 3), such as the Internet. Furthermore, the information providing device 10 can perform communication with an arbitrary number of the terminal devices 100 and a plurality of delivery devices 200.

The terminal device 100 is implemented by various information processing devices, such as smart devices including smartphones, tablets, and the like or personal computers (PC). For example, the terminal device 100 has a function for displaying various kinds of information.

The delivery device 200 is an information processing device having a function for delivering various kinds of information and is implemented by a server device or a cloud system. For example, the delivery device 200 implements a service that provides news to users. For example, the delivery device 200 generates a heading of a posted sentence and provides the generated heading to the terminal device 100. Then, the delivery device 200 provides the sentence associated with the heading selected by the terminal device 100 to the terminal device 100.

The embodiment is not limited to this and the delivery device 200 may also provide an arbitrary service to a user. For example, in addition to news, the delivery device 200 may also set, as a delivery target, articles posted to various web sites or various kinds of posted information posted by a user and may also deliver a heading of a sentence included in the posted information that becomes the delivery target.

### 1-1. Generating a Heading

Here, the delivery device 200 provides a service, such as a Q&A service, for distributing information posted from a user to other users. For example, the delivery device 200 sends information (i.e., a heading), such as a title or thumbnails, implying the content of a body text to the user. Then, if the user has selected the heading, the delivery device 200 delivers the body text associated with the selected heading to the user.

Here, in order to reduce a trouble of posting, it is conceivable to use a method of receiving only registration of a body text and generating a sentence that becomes a heading from the received body text. As a technology for generating a sentence, it is conceivable to use a technology for generating, by using a model, such as a deep neural network (DNN), a sentence that becomes a heading from a body text. Furthermore, here, the DNN may also be a convolutional neural network (CNN) or a recurrent neural network (RNN). Furthermore, the RNN may also be a long short-term memory (LSTM) or the like. In a description below, as a model, an example of using an RNN will be described.

For example, the delivery device 200 prepares an RNN and acquires a set of a sentence and a heading that become learning data. For example, the delivery device 200 acquires, as learning data, a set of a sentence and a sentence that become the heading of the sentence. Then, the delivery device 200 performs learning of the RNN such that, when, for example, a feature value held by the sentence is input to the RNN, the RNN outputs the feature value of the sentence that becomes the heading.

For example, the delivery device 200 specifies each of the words included in the sentence and sequentially inputs a value (i.e., a feature value) indicating each of the words to the RNN in the order in which each of the words has appeared in the sentence. Then, the delivery device 200 performs learning of the RNN such that the RNN sequentially outputs a probability of appearance of each of the words in the sequential order of the words that are included in the heading. For example, the delivery device 200 performs learning of the RNN such that the RNN outputs a probability of appearance of each of the words in the heading first time and then outputs a probability of appearance of each of the words in the heading second time.

More specifically, the delivery device 200 selects a word estimated to appear in the heading first time based on the probability that was output by the RNN. Then, the delivery device 200 performs learning of the RNN such that the RNN outputs the probability of appearance of each of the words in the heading second time at the time of input of the feature values of the selected words to the RNN. Namely, the delivery device 200 performs learning of the RNN such that, when the words included in the sentence are sequentially input, the RNN outputs the first word included in the heading and, after that, when the output words are sequentially input, the RNN sequentially outputs the second word and the subsequent words included in the heading. Furthermore, such an RNN is sometimes referred to as an encoder=decoder model.

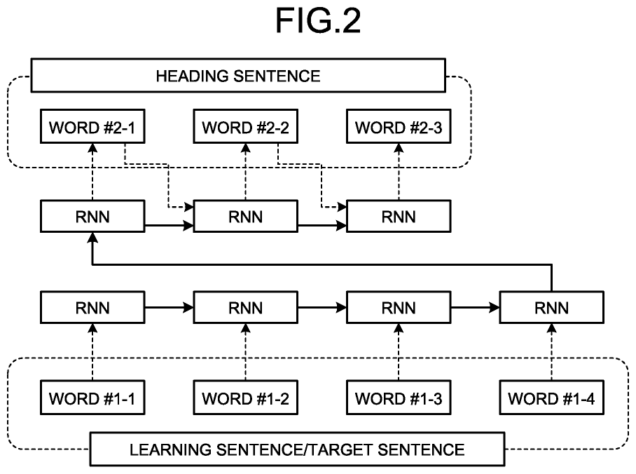

For example, FIG. 2 is a diagram illustrating an example of a model generated by the information providing device according to the embodiment. For example, the information providing device 10 extracts a word #1-1 to a word #1-4 included in a learning sentence that is a sentence used for the learning of the models or included in a target sentence (hereinafter, collectively referred to as an “input sentence”) that becomes a processing target. Then, the information providing device 10 inputs the word #1-1 to the word #1-4 to the RNNs in the appearance order of the words in the sentence. For example, the information providing device 10 inputs the feature value of the word #1-1 to the RNN; then, inputs the feature value of the word #1-2 to the RNN; then, inputs the feature value of the word #1-3 to the RNN; and lastly inputs the feature value of the word #1-4 to the RNN. Furthermore, after having input the feature value of the word #1-4, the information providing device 10 may also input, to the RNN, the feature value of the information on, for example, an expression of the end of a sentence, suggesting that all of the words included in an input sentence have been input.

In this way, when all of the words included in the input sentence have been input, the RNNs output the words included in the heading sentence associated with the input sentence in the appearance order of the words in the heading sentence. Namely, when all of the words included in the input sentence have been input, the information providing device 10 performs learning of the RNN such that the words included in the heading sentence are sequentially output. For example, when all of the words included in the input sentence have been input, the RNN outputs the word #2-1 that is included in the heading sentence. Subsequently, the RNN accepts an input of the word #2-1 that was output last time. Then, when the RNN has accepted an input of the word #2-1, the RNN outputs a word #2-2 that appears subsequent to the word #2-1 in the heading sentence. Furthermore, the RNN accepts an input of the word #2-2 that was output last time. Then, when the RNN accepts an input of the word #2-2, the RNN outputs the word #2-3 that appears subsequent to the word #2-2 in the heading sentence.

In contrast, when generating information associated with input information, there is a known technology for using an ensemble method in which, when information associated with input information is generated, a plurality of generation results is used in order to increase the accuracy of generating information. For example, the information processing device that uses the technology for using the ensemble method prepares a plurality of RNNs in each of which learning has been individually performed and inputs, to each of the RNNs, each of the words included in the sentence that becomes a processing target in the order in which the words appear in the sentence. Subsequently, the information processing device calculates the average value of the probabilities of the plurality of output RNNs. For example, the information processing device calculates, for each word, an average value of the probability that is related to each of the words appearing first time in the heading and that has been output from each of the RNNs. Then, the information processing device selects the word having the highest value of the average value as the word that appears first in the heading and inputs the selected word to each of the RNNs, thereby the information processing device calculates the probability of appearance of each word second time in the heading.

However, in the conventional technology described above, it is not possible to efficiently generate a heading. For example, in the technology described above, an average value is calculated by each of the RNNs outputting the probability and calculates, by selecting the word included in the heading based on the calculated average value and again inputting the selected word to each of the RNNs, the probability of appearance of each of the word next time. Consequently, in the conventional technology, all of the RNNs need to wait for each steps of estimating each of the words included in the heading until all of the RNNs output the probabilities, which does not always demonstrate an efficient process.

### 1-2. Process Performed by the Information Providing Device

Thus, the information providing device 10 performs an output process described below. First, the information providing device 10 acquires a plurality of pieces of output information generated from predetermined target information by a plurality of models that generates output information that includes a plurality of pieces of information having an order relation from input information. Furthermore, the information providing device 10 selects, based on the similarity between the plurality of pieces of output information, from among the plurality of pieces of output information, output information that is to be output as association information that is associated with the target information. Then, the information providing device 10 outputs the selected output information as association information.

More specifically, if output information is input as a model, the information providing device 10 acquires output information that has been generated by a recurrent neural network that outputs new information. Furthermore, the information providing device 10 acquires output information generated by a plurality of models that are generated from a plurality of models in each of which a connection coefficient of a node is randomly different and that is allowed to learn the feature individually held by each of the pieces of learning information. Furthermore, the information providing device 10 acquires a plurality of pieces of output information generated from predetermined target information by a plurality of models each of which includes an encoder that generates, when the input information including a plurality of pieces of information is input as the model, feature information indicating the feature held by the input information and a decoder that sequentially generates a plurality of pieces of information included in the output information from the feature information that has been generated by the encoder.

For example, the information providing device 10 prepares a plurality of models each of which outputs a heading of an input sentence from a text (hereinafter, referred to as an “input sentence”) that becomes the input information. Furthermore, the information providing device 10 generates, by individually using each of the models, a plurality of candidates for a heading from the target sentence that becomes a processing target. Then, the information providing device 10 specifies the similarity between the candidates and selects, based on the selected similarity, from among the candidates for the heading output by each of the models, the candidates to be output as the heading of the target sentence. For example, the information providing device 10 selects, from among the candidates, the candidate in which the similarity with the other candidate is the highest as an output target.

In this way, the information providing device 10 generates output information (for example, a candidate for a heading) that includes a plurality of pieces of information by individually using different models from the input information (for example, a sentence) that includes a plurality of pieces of information (for example, words) having an order relation. As the result of the process described above, the information providing device 10 can distribute the process of generating output information from output information, thereby implementing the efficiency of the process. Furthermore, because the information providing device 10 selects the output information corresponding to the output target based on the similarity between each of the pieces of output information, it is possible to implement the efficiency of the process while preventing a decrease in accuracy of the output information that is to be output. Namely, the information providing device 10 performs a post ensemble process that ensembles the output of each of the model as a posterior process.

For example, when each of the models individually generates a candidate for a heading from the same sentence, if the learning of each of the models is appropriately performed, it is conceivable that the content of the candidate generated by each of the models is similar. Thus, if appropriate learning is performed, it is conceivable that the content of the candidates generated by some models from among the plurality of models is similar. Consequently, it is conceivable that, regarding the candidate that is appropriate for a heading of a certain sentence, the similarity between the candidates generated by the corresponding models becomes high. In other words, when each of the candidates is projected onto the space in which the similarity between the candidates is regarded as a distance, it is estimated that the candidates included in a region (i.e., a region in which the density of candidates is high) in which a larger number of candidates are projected is similar to a more appropriate heading.

Thus, the information providing device 10 specifies the similarity between the candidates generated by each of the models and selects, as output targets from among the candidates generated by each of the models, the candidates in each of which the similarity with the other candidates is higher. For example, the information providing device 10 selects the candidates for the output target based on the semantic similarity of the candidate generated by each of the models.

For example, the information providing device 10 generates a distributed representation associated with a candidate by replacing each of the words included in the candidates for the heading with an associated value and calculates the cosine similarity between the generated distributed representations. Furthermore, the information providing device 10 may also generate a vector that is associated with each of the plurality of pieces of information included in the output information and may also generate the vector, which is obtained by integrating the generated vectors, as a vector associated with the candidate. Furthermore, the information providing device 10 may also convert each of the headings to a distributed representation by using various methods (for example, word2vec) for projecting words or sentences onto distributed representation space based on the semantic similarity.

Then, the information providing device 10 selects a candidate in which the similarity with the other candidate is high from among the candidates. For example, the information providing device 10 may also calculate the degree of similarity (for example, the cosine similarity) between the candidates and may also select the candidate in which the sum of the calculated degree of similarity is the maximum as a heading. Furthermore, the information providing device 10 projects, based on the degree of similarity between the candidates, each of the candidates onto arbitrary space and specifies an area (i.e., an area in which the density of the candidate is the highest) in which the number of candidates projected onto the space is the maximum. Then, the information providing device 10 may also select the candidates included in the specified area as the output target. For example, the information providing device 10 may also select the candidate that is closest to the center of the specified area or may also calculate an average value of the distributed representation of the candidates projected onto the specified area and selects, as a heading, the candidates associated with the distributed representation closest to the calculated average value.

### 1-3. Consideration of Distribution

Here, an example in which a candidate (hereinafter, sometimes simply referred to as a “heading”) for a heading is generated from a certain input sentence by using an infinite number of learned models will be considered. In this case, it is conceivable that, if each of the headings is projected onto the space assuming that the degree of similarity between headings is the distance on a predetermined space, a larger number of headings are projected in an area in which an appropriate heading is projected as the heading of the input sentence when compared with the other areas. If a distribution of such headings is regarded as a probability distribution of a heading that is output from each of the learned models, it is conceivable that a heading appropriate for the heading of the input sentence is projected in a region in which a heading generated by each of the models is highly likely to be projected.

Thus, the information providing device 10 estimates, based on the similarity between the headings, the probability distribution of the headings that are likely to be generated from the input sentence. Then, the information providing device 10 may also select, from among the headings, the heading included in the predetermined area in the probability distribution as the output target. For example, the information providing device 10 estimates the probability density function of the headings that are likely to be generated from a predetermined input sentence by using kernel density estimation that regards the headings generated by the plurality of models as samples. Then, the information providing device 10 selects a heading that is an output target in an area in which a larger number of headings are likely to be included indicated by a probability density function, i.e., from among headings projected in a region in which the density is higher.

For example, the information providing device 10 selects a kernel function that is the population in kernel density estimation. For example, the information providing device 10 may use, as the kernel function, a function indicating an arbitrary distribution, such as a Gaussian distribution, a logistic distribution, the von Mises distribution, and the von Mises-Fisher distribution. Then, the information providing device 10 estimates a probability density function belonging to a sample by using kernel density estimation.

For example, the information providing device 10 estimates a probability density function formed by the heading candidate by regarding the cosine similarity of the heading generated by each of the models (hereinafter, sometimes referred to as a “heading candidate”) as the degree of similarity between the samples. Furthermore, the information providing device 10 specifies the region in which the density of the probability exceeds a predetermined threshold in the estimated probability density function and extracts the heading candidates, from among the heading candidates, projected in the specified region. Then, the information providing device 10 selects the heading candidates to be output as the heading of the input sentence from among the extracted heading candidates. For example, the information providing device 10 may also calculate an average value of the distributed representation of the extracted heading candidates and select a heading candidate that is closest to the calculated average value.

In the following, an example of a process performed by the information providing device 10 will be described by using Expressions. In a description below, an output (i.e., a heading candidate) in a case where an input sentence x is input to a certain learning model p is represented by s. In this case, a set S of the heading candidates can be represented by Expression (1) below. Furthermore, it is assumed that curly brackets { } in Expression (1) indicate hash or distributed representation.

S←S∪{s} (1)

Subsequently, as indicated by Expression (2) below, the information providing device 10 calculates, regarding a certain output s, a score c based on the degree of similarity between all of the other outputs s′. Here, K (s, s′) represented in Expression (2) is a kernel function that is used to calculate the degree of similarity between the output s and the output s′. Namely, the score c is the average value of the similarities between the other outputs.

$$c ← \frac{1}{\vert S \vert} {\sum }_{{s}^{′} ∈ S} K ( s , {s}^{′} ) \qquad ( 2 )$$

Subsequently, as indicated by Expression (3) below, the information providing device 10 sets the set of the score c of each of the outputs s to C[s] and selects, as indicated by Expression (4), the output s in which the value of the score c is the highest from the set S.

C[s]←c (3)

y=arg max_{s∈S}C[s] (4)

Furthermore, the cosine similarity is used as the degree of similarity of each of the heading candidates, the function K in Expression (2) can be represented by Expression (5) below.

K(s,s′)=cos(s,s′) (5)

Subsequently, kernel density estimation will be described. For example, if a probability density function targeted for estimation is represented by f and the samples in the probability density function f are represented by X₁ to Xₙ, an amount of the kernel density estimation can be represented by Expression (6) below.

$$\tilde{f} ( X ) = \frac{1}{n} {\sum }_{i = 1}^{n} K ( X , {X}_{i} ) \qquad ( 6 )$$

Here, it is assumed that learning has been performed on each of the models p₁˜pₙ from random parameters θ₁ to θₙ, respectively, and output the outputs s₁ to sₙ, respectively. Here, if the parameters θ₁ to θₙ are independent and identically distributed random variables, it is conceivable that the output sᵢ based on the parameter θᵢ also independent and identically distributed random variable. Thus, Expression (2) is conceivably equivalent to Expression (6). Thus, by selecting the headings to be output from the heading candidates by using Expression (2) described above, the information providing device 10 can obtain the probability density function indicating the distribution of the heading candidates that is likely to be generated from the input sentence and can select the heading based on the probability distribution indicated by the probability density function.

Here, the information providing device 10 can use Gaussian kernel K_{gaus}(s, s′) represented by Expression (7) below as a kernel function K represented by Expression (2). Here, h denotes an allowable parameter of smoothing. Furthermore, m denotes is the number of dimensions of the output s. Furthermore, d (s, s′) denotes the distance between the output s and the output s′ and is a function represented by Expression (8) below.

$$\begin{matrix}{K}_{gaus} ( s , {s}^{′} ) = \frac{1}{2 π {h}^{m}} exp ( \frac{{d ( s , {s}^{′} )}^{2}}{2 h} ) & ( 7 ) \\ d ( s , {s}^{′} ) = {‖ s - {s}^{′} ‖}_{2} & ( 8 )\end{matrix}$$

Furthermore, the information providing device 10 can use the von Mises-Fisher kernel K_{vmf}(s, s′) represented by Expression (9) below as the kernel function represented by Expression (2). Here, Iᵥ in Expression (9) denotes the v-th order Bessel function and q denotes the number of dimensions. Furthermore, C_{q}(κ) in Expression (9) denotes a normalization constant and can be represented by Expression (10) below. Furthermore, κ with a tilde in Expression (10) denotes an approximate value of κ in maximum likelihood estimation and can be represented by Expression (11) below. Furthermore, μ with a tilde in Expression (11) denotes a cosine distance between the output s and the output s′.

$$\begin{matrix}{K}_{vmf} ( s , {s}^{′} ) = {C}_{q} ( κ ) exp ( κ cos ( s , {s}^{′} ) ) & ( 9 ) \\ {C}_{q} ( κ ) = \frac{{κ}^{\frac{q - 1}{2}}}{{( 2 π )}^{\frac{q + 1}{2}} {L}_{\frac{q - 1}{2}} ( κ )} & ( 10 ) \\ \tilde{κ} = \frac{\tilde{μ} ( q - \tilde{μ} )}{1 - {\tilde{μ}}^{2}} & ( 11 )\end{matrix}$$

### 1-4. Example of the Output Process

In the following, an example of the output process performed by the information providing device 10 will be described with reference to FIG. 1. First, the information providing device 10 accepts a target sentence that becomes a target for generating a heading from the delivery device 200 (Step S1). For example, the information providing device 10 accepts, from the delivery device 200, the sentence posted by a user as a target sentence.

In this case, the information providing device 10 generates a plurality of headings of the target sentence by using a plurality of models each of which generates a heading from the sentence (Step S2). For example, the information providing device 10 prepares n RNNs obtained by randomly changing an initial parameter as models #1 to #n and allows each of the models #1 to #n to learn so as to generate a heading sentence from the input sentence by using predetermined learning data. Then, the information providing device 10 individually inputs each of the target sentences to the corresponding models #1 to #n and acquires headings #1 to #n that were individually input the models #1 to #n, respectively.

Namely, instead of integrating, one by one, the words generated by each of the models #1 to #n from the target sentence, the information providing device 10 independently use each of the models #1 to #n and generates the headings #1 to #n from the target sentence. For example, the information providing device 10 inputs the words included in the target sentence to the model #1 in the appearance order of the words and then again sequentially input the words output by the model #1 thereafter to the model #1, thereby outputting the words included in the heading #1 from the model #1 in the appearance order of the words. In this way, because the information providing device 10 individually uses each of the models #1 to #n and individually outputs the plurality of the headings #1 to #n, for example, it is possible to generate the headings #1 to πn by using the models #1 to #n, respectively, in parallel.

Subsequently, the information providing device 10 specifies each of the degree of similarity between the headings (Step S3). For example, the information providing device 10 performs distributed representation on each of the headings #1 to #n. For example, the information providing device 10 may also convert the headings to the distributed representation by converting each of the words included in the corresponding headings to an associated predetermined value by using word2vec. Furthermore, the information providing device 10 may also perform distributed representation on each of the headings by using an arbitrary method for performing distributed representation on various sentences.

Then, the information providing device 10 specifies the degree of similarity between the distributed representation of each of the headings. For example, the information providing device 10 specifies the cosine similarity between the distributed representation of each of the headings. For example, the information providing device 10 calculates the cosine similarity between the distributed representation of the heading #1 and the distributed representation of the heading #2 as the degree of similarity #1-2 between the heading #1 and the heading #2.

Then, the information providing device 10 selects, based on the specified degree of similarity, from the headings #1 to #n generated by the models #1 to #n, respectively, the heading that is output as the heading of the target sentence. Namely, the information providing device 10 estimates, based on the specified degree of similarity, a probability density function of the heading that is likely to be generated from the target sentence and selects, based on the degree of similarity between the headings, the headings included in the region in which a lot of headings that is likely to belong in the probability distribution indicated by the probability density function, i.e., in the probability distribution of the headings that are likely to be generated from the target sentence (Step S4).

For example, if it is assumed that the headings #1 to πn generated by the models #1 to #n, respectively, are regarded as samples, the similarities among the headings #1 to #n can be regarded as the similarities among the samples. Here, as indicated at Step S4 illustrated in FIG. 1, when each of the headings #1 to #n is projected onto one-dimensional space based on the similarity, it can be said that the headings projected onto the region in which a lot of similar headings are generated are projected onto an area in which a lot of similar headings are likely to be generated. Here, if appropriate learning is performed on a plurality of models, it is estimated that an output of a lot of models approaches appropriate headings. In other words, in a probability distribution represented by a probability density function in which each of the headings is estimated as a sample, it is conceivable that more appropriate headings are projected onto the region in which a larger number of headings belong. Thus, the information providing device 10 selects the heading (for example, a heading #X) that satisfies Expression (4) described above as the output target. Namely, the information providing device 10 selects the heading that is closest to the area in which the largest number of headings has likely to be projected (i.e., an area with the highest probability distribution).

Then, the information providing device 10 provides the heading to the delivery device 200 (Step S5). In this case, the delivery device 200 delivers the heading to the terminal device 100 (Step S6). Furthermore, the terminal device 100 requests the delivery device 200 to deliver the sentence selected by the user based on the heading (Step S7). In this case, the delivery device 200 delivers the requested sentence to the terminal device 100 (Step S8).

### 1-5. Application Target

In the example described above, the information providing device 10 generates candidates for a plurality of headings from a target sentence by individually using a plurality of models each of which generates a heading including a plurality of words from an input sentence that includes a plurality of words and selects, based on the similarities among the headings, the heading of the target sentence from among the candidates for the headings. However, the embodiment is not limited to this. The output process described above can be used for arbitrary information as long as a plurality of continuous pieces of information is used as an input or an output of the models.

For example, it can be said that voice data is information in which the frequencies of the voice are sequentially arranged in time series. The information providing device 10 may perform the output process described above on this voice data. For example, the information providing device 10 generates a plurality of models each of which generates new voice data from the voice data. More specifically, the information providing device 10 may also generate a plurality of models each of which converts voice data that includes male voices to voice data that includes female voices and may also generate a plurality of models each of which converts voice data that includes adult voices to voice data that includes children's voices. Furthermore, the information providing device 10 may also generate a plurality of models each of which generates voice data that corresponds to a summary of the voice data.

Then, the information providing device 10 individually inputs the voice data corresponding to the processing target to each of the models and selects, based on the degree of similarities among the pieces of voice data that are individually output by each of the models, the voice data associated with the voice data that corresponds to the processing target. Namely, the information providing device 10 selects voice data that is associated with the input voice data and that is used as an output target based on the degree of similarities among the pieces of the voice data from among the pieces of voice data that are individually generated by each of the models.

Furthermore, the information providing device 10 may also perform the output process described above on arbitrary information as long as, for example, moving image, information indicating a change in stock price in time series, information indicating a change in traffic congestion in time series, or the like, information that includes a plurality of pieces of information and in which the appearance order of each of the pieces of information has a meaning is used as input information and, similarly, information that includes a plurality of pieces of information and in which the appearance order of each of the pieces of information has a meaning is used as output information.

### 2. Example of a Functional Configuration Held by the Information Providing Device

In the following, an example of the functional configuration held by the information providing device 10 that implements the detecting process and the delivery process described above will be described. FIG. 3 is a diagram illustrating a configuration example of the information providing device according to the embodiment. As illustrated in FIG. 3, the information providing device 10 includes a communication unit 20, a storage unit 30, and a control unit 40.

The communication unit 20 is implemented by, for example, a network interface card (NIC) or the like. Then, the communication unit 20 is connected to a network N in a wired or a wireless manner and sends and receives information to and from an arbitrary device.

The storage unit 30 is implemented by, for example, a semiconductor memory device, such as a random access memory (RAM) or a flash memory, or a storage device, such as a hard disk or an optical disk. Furthermore, the storage unit 30 stores therein a learning data database 31 and a model database 32.

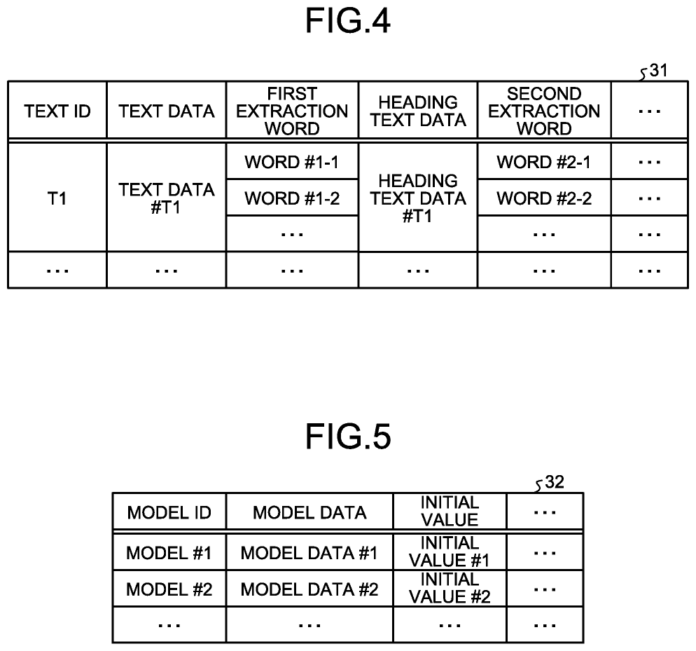

In the learning data database 31, learning data that is used for learning performed by a model is registered. For example, FIG. 4 is a diagram illustrating an example of information registered in the learning data database according to the embodiment. As illustrated in FIG. 4, in the learning data database, information having items, such as “text ID (Identifier)”, “text data”, “first extraction word”, “heading text data”, “second extraction word”, and the like are registered.

Here, the “text ID” is an identifier for a sentence that becomes the learning data, i.e., an identifier for a learning sentence. Furthermore, the “text data” is text data of the learning sentence. Furthermore, “the first extraction word” is a word extracted from the associated learning sentence and is registered in the order in which the words are extracted from the associated text data. Furthermore, the “heading text data” is text data that becomes the heading of the associated text data. Furthermore, “the second extraction word” is a word extracted from the associated heading text data and is registered in the order in which the words are extracted from the associated text data.

Furthermore, in the example illustrated in FIG. 4, conceptual values, such as “text data #T1”, a “word #1-1”, “heading text data #T1”, and a “word #2-1”, are represented; however, in practice, a learning sentence, text data of a heading, a text of a word, and the like are registered. Furthermore, in addition to the information illustrated in FIG. 4, arbitrary information related to the learning data may also be registered in the learning data database 31.

For example, in the example illustrated in FIG. 4, in the learning data database 31, text data of the “text data #T1” is registered as the learning sentence indicated by the text ID “T1” and, furthermore, the “word #1-1” and a “word #1-2” that are included in the text data of the “text data #T1” are registered in the order of the appearance in the text data of the “text data #T1”. Furthermore, in the learning data database 31, as a heading associated with the text data of the “text data #T1”, heading text data of the “heading text data #T1” is registered and, furthermore, the “word #2-1” and the “word #2-2” that are included in the heading text data of the “heading text data #T1” are registered in the order of the appearance in the heading text data of the “heading text data #T1”.

A description will be continued by referring back to FIG. 2. In the model database 32, a plurality of models each of which generates, from input information that includes a plurality of pieces of information having sequential order, output information that includes a plurality of pieces of information having sequential order is registered. More specifically, in the model database 32, a plurality of models that are obtained by randomly changing the initial parameter and that output each of the words included in the output sentence in the appearance order of the words if each of the words included in the input sentence is input in the appearance order of the words is registered. For example, in the model database 32, RNNs each of which generates a heading of the input sentence are registered.

For example, FIG. 5 is a diagram illustrating an example of information registered in the learning data database according to the embodiment. As illustrated in FIG. 5, in the learning data database, information having items, such as “model ID”, “model data”, “initial value”, and the like, is registered.

Here, the “model ID” is an identifier for identifying a model. Furthermore, the “model data” is data of a model and, for example, the connection relation between nodes constituting RNNs, a connection coefficient in a connection path that connects the nodes (i.e., the weight used for the value output by each of the nodes), and the like are registered. Furthermore, the “initial value” is information indicating the initial value used when each of the models is generated and is the initial value of, for example, a connection coefficient between nodes constituting the RNN.

In the example illustrated in FIG. 5, in the model database 32, the model ID “model #1”, the model data “model data #1”, and the initial value “initial value #1” are registered in an associated manner. This information indicates that the data of the model indicated by the model ID of the “model #1” is the model data of the “model data #1” and the “model #1” is the model in which learning has been performed from the initial value of the “initial value #1”.

Furthermore, in the example illustrated in FIG. 5, conceptual values, such as the “model data #1”, the “initial value”, and the like, are represented; however, in practice, a value indicating the connection relation or the connection coefficient is registered. Furthermore, in addition to the information illustrated in FIG. 5, arbitrary information related to the model may also be registered in the model database 32.

A description will be continued by referring back to FIG. 3. The control unit 40 is a controller and is implemented by, for example, processor, such as a central processing unit (CPU), a micro processing unit (MPU), or the like, executing various kinds of programs, which are stored in a storage device included in the information providing device 10, by using a RAM or the like as a work area. Furthermore, the control unit 40 is a controller and may also be implemented by, for example, an integrated circuit, such as an application specific integrated circuit (ASIC), a field programmable gate array (FPGA).

As illustrated in FIG. 4, the control unit 40 includes a learning unit 41, an acquiring unit 42, an estimating unit 43, a selecting unit 44, and an output unit 45.

The learning unit 41 performs learning on a plurality of models each of which generates output information that includes a plurality of pieces of information having an order relation from input information. More specifically, the learning unit 41 individually allows a plurality of models generated from a plurality of models in each of which a connection coefficient between the nodes is randomly different to learn the feature held by the learning information. For example, the learning unit 41 performs learning of a recurrent neural network.

For example, the learning unit 41 generates, as models, a plurality of RNNs obtained by randomly changing each of the values of the connection coefficients. Subsequently, the learning unit 41 uses the learning data registered in the learning data database 31 and individually performs learning on each of the models. For example, the learning unit 41 corrects the connection coefficients held by the models such that, when the first extraction words extracted from certain text data are sequentially input to the models, the second extraction words extracted from the heading text data that is associated with the subject text data are sequentially output. Namely, the learning unit 41 performs learning on an encoder decoder model having an encoder and a decoder.

More specifically, the learning unit 41 trains the models to perform learning such that, after having input all of the first extraction words, each of the models outputs the word that appears first from among the second extraction words and, when further inputting the subject word, each of the models output the word that appears second time from among the second extraction words. Furthermore, regarding the learning, arbitrary learning, such as back propagation, can be used. Then, the learning unit 41 performs learning on each model and registers the learned models in the model database 32.

The acquiring unit 42 acquires a plurality of pieces of output information that is generated from predetermined target information by a plurality of models each of which generates output information that includes a plurality of information having an order relation from the input information. For example, if the output information is input as a model, the acquiring unit 42 acquires the output information generated by the recurrent neural network that outputs new information. Furthermore, the information providing device 10 acquires the output information generated by a plurality of models that have been generated from a plurality of models in each of which the connection coefficient between the nodes is randomly different and that have been allowed to individually learn the feature held by each of the pieces of learning information.

For example, the acquiring unit 42 outputs a plurality of pieces of output information generated from predetermined target information by a plurality of models each of which includes an encoder that generates, when the input information that includes a plurality of pieces of information is input as a model, feature information indicating the feature held by the input information and a decoder that sequentially generate a plurality of pieces of information included in the output information from the feature information generated by the encoder. Furthermore, for example, the acquiring unit 42 acquires a plurality of pieces of output information generated, from the target information that is a text, by a plurality of models each of which generates the output information that is a text from the input information that is a text. Furthermore, the acquiring unit 42 acquires a plurality of pieces of output information generated, from the target information that is a text, by a plurality of models each of which generates, from the input information that is a text, the output information that is a heading of a text or that is a text corresponding to a summary.

For example, the acquiring unit 42 accepts a target sentence that becomes a processing target from the delivery device 200. In this case, the acquiring unit 42 performs the following process for each model registered in the model database 32. First, the acquiring unit 42 extracts the words included in the target sentence and inputs the feature values of the extracted words to the model in the appearance order of the words. Subsequently, the acquiring unit 42 specifies the word that appears first in the heading based on the feature value that has been output by the model first time and again inputs the feature value that has been output by the model to the, thereby the acquiring unit 42 allows the model to output the feature value of the word that appears subsequent to the output word. Then, by again inputting the feature value that has been output by the model to the model every time the model outputs a feature value, the information providing device 10 acquires the feature value of each of the words included in the heading in the appearance order of the words. Thereafter, the acquiring unit 42 specifies each of the words included in the heading from the acquired feature values and generates a text that becomes the heading from the specified words.

The estimating unit 43 estimates, based on the similarity between the pieces of output information, a probability distribution of the pieces of output information that are likely to be generated from predetermined target information. For example, based on the kernel density estimation in which the output information generated by the plurality of models is regarded as samples, the estimating unit 43 estimates a probability distribution of the pieces of output information that is likely to be generated from predetermined target information.

For example, the estimating unit 43 converts each of the headings acquired by the acquiring unit 42 to distributed representation and calculates the degree of similarity of each of the pieces of distributed representation. For example, the estimating unit 43 calculates the degree of similarity of each of the pieces of distributed representation by using Expression (5) and Expression (7) or Expression (9) described above. Then, the estimating unit 43 calculates the score c of each of the pieces of distributed representation by using Expression (2). Here, the process of calculating each of the score c of each of the pieces of distributed representation by using Expression (2) is the same as the process of estimating the probability density function, in which each of the headings are regarded as a sample, by using Expression (6), i.e., the process of estimating a probability distribution of the pieces of output information that is likely to be generated from predetermined target information by using the kernel density estimation in which the headings that have been output by a plurality of models are regarded as samples.

The selecting unit 44 selects, based on the similarity between the plurality of pieces of output information, the output information that is to be output as the association information that is associated with the target information from among the plurality of pieces of output information. Furthermore, the selecting unit 44 selects the output information to be output as the association information based on the semantic similarity between the plurality of pieces of output information. Furthermore, the selecting unit 44 selects the output information to be output as the association information based on the cosine similarity between the vectors associated with the plurality of pieces of output information. For example, the selecting unit 44 generates a vector obtained by integrating vectors each of which is associated with one of the corresponding pieces of information included in the output information as a vector associated with each of the pieces of information included in the output information and selects the output information that is to be output as the association information based on the cosine similarity between the generated vectors.

Here, the selecting unit 44 selects, from among the plurality of pieces of output information, the output information in which the similarity with another piece of output information is high. Namely, the selecting unit 44 selects, from among the plurality of pieces of output information, the output information that is included in a predetermined area in the probability distribution. In other words, the selecting unit 44 selects, in the probability distribution, the output information that is included in the area in which a greater number of pieces of output information is likely to be included.

For example, the selecting unit 44 acquires the score c of each of the headings represented by Expression (2). Then, the selecting unit 44 selects, from among the headings, the heading having the highest value of the score c as an output target. Namely, in the probability distribution of the headings that are likely to be generated, the selecting unit 44 selects, from among the headings generated by the models, the headings in the area in which the largest number of headings that are likely to be generated. In other words, the selecting unit 44 selects the heading that is highly likely to be suitable as a heading.

The output unit 45 outputs the output information that has been selected by the selecting unit 44 as the association information. For example, the output unit 45 outputs, to the delivery device 200, the heading selected by the selecting unit 44 as the heading of the input sentence.

### 3. Flow of the Process Performed by the Information Providing Device

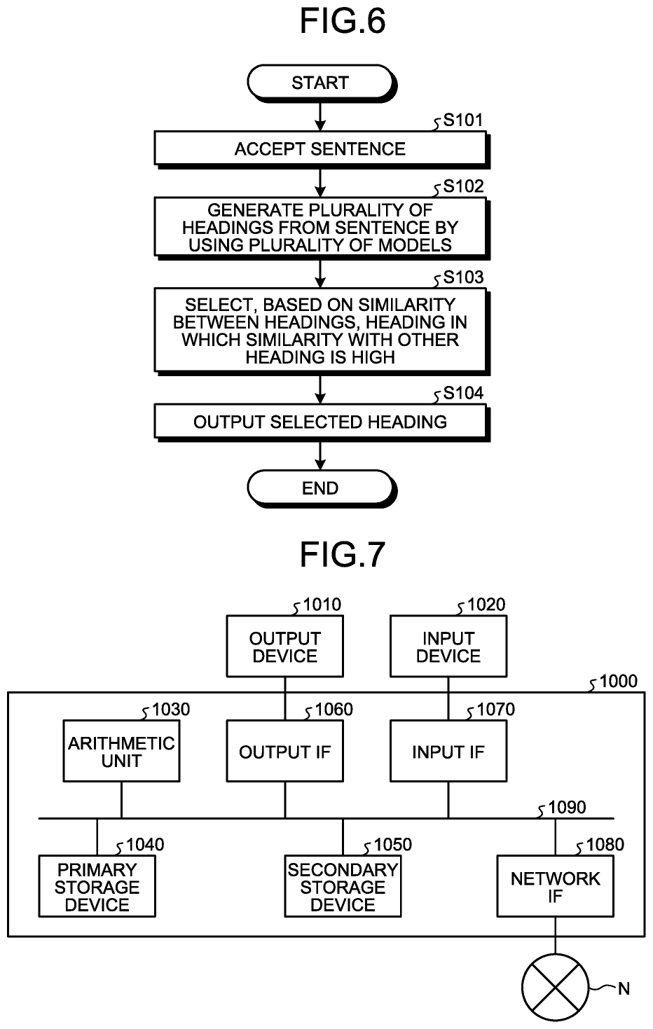

In the following, an example of the process performed by the information providing device 10 will be described with reference to FIG. 6. FIG. 6 is a flowchart illustrating an example of the flow of an output process performed by the information providing device according to the embodiment.

First, when the information providing device 10 accepts a sentence (Step S101), the information providing device 10 generates a plurality of headings from the sentence by using a plurality of models (Step S102). Then, the information providing device 10 selects, based on the similarity between the headings, the heading in which the similarity with the other heading is high (Step S103). Thereafter, the information providing device 10 outputs the selected heading as the heading of the accepted sentence (Step S104) and ends the process.

### 4. Modification

In the description above, an example of the output process performed by the information providing device 10 has been described. However, the embodiment is not limited to this. In the following, a variation in the process performed by the information providing device 10 will be described.

### 4-1. Model

In the description above, the information providing device 10 uses RNNs as models. More specifically, the information providing device 10 uses the models each of which outputs, when pieces of information included in the input information are input in an appearance order, the pieces of information included in output information in an appearance order and each of which outputs, when the information that has been output last time is again input, information that appears subsequent to the subject information. However, the embodiment is not limited to this.

For example, the information providing device 10 may also generate candidates for a plurality of headings by using a plurality of models that are implemented by CNN or LSTM and may also select the candidate for the heading based on the similarity between the generated candidates. Furthermore, the information providing device 10 may also use models each having a different type. For example, the information providing device 10 may also generate candidates for the output information that is associated with the input information by using each of CNN, LSTM, and RNN that generate the output information from the input information and may also select candidates for the output information based on the similarity between the generated candidates.

In this way, the information providing device 10 may also generate the output information from the input information by individually using the plurality of models regardless of the type of models and may also select the output information that is used as the output target from among the pieces of the generated output information based on the similarity between the pieces of generated output information. By performing this process, because the information providing device 10 implements the process of generating, in parallel, the output information from the input information by using each of the models, it is possible to implement a process of efficiently generating the output information.

### 4-2. Initial Value of Each of the Models

In the description above, the information providing device 10 generates candidates for the output information by individually using the plurality of models in each of which learning has been performed started from random initial values. However, the embodiment is not limited to this. The information providing device 10 can use the models in each of which learning has been performed by using an arbitrary method as long as candidates for a plurality of pieces of output information are individually generated by using different models and the output information is selected from the candidates for the generated output information.

For example, the information providing device 10 may also acquire output information generated from a plurality of models that are generated from an identical model and that are allowed to learn the feature held by the learning information up to different stages. For example, the information providing device 10 prepares a single model and allows the model to learn the feature held by the learning information. At this time, if the information providing device 10 moves forward the learning of the model to a certain stage, the information providing device 10 generates a copy of the model and uses the copy of the generated model as the first model. Furthermore, if the information providing device 10 further moves forward the learning performed on the model to a certain stage, the information providing device 10 uses the copy of the model as the second model. Namely, the information providing device 10 prepares a plurality of models that have been generated from a single model and each of which has a different learning stage. Then, the information providing device 10 may also generate candidates for the output information by using the plurality of prepared models.

Furthermore, for example, the information providing device 10 may also acquire the output information generated by a plurality of models each having a different connection relation between nodes. Namely, the information providing device 10 may also generate candidates for the output information by using a plurality of models each having a different structure.

Furthermore, for example, the information providing device 10 may also acquire output information generated by a plurality of models each of which has learned the feature of different pieces of learning target information and each of which has learned the feature of a plurality of pieces of learning target information generated from predetermined learning information. Namely, the information providing device 10 may also use a plurality of models in each of which learning has been performed by using a method of Bagging. For example, the information providing device 10 generates a plurality of pieces of learning target information from the learning information by using bootstrap sampling. Then, the information providing device 10 may also prepare a plurality of models in each of which learning has been performed by using difference pieces of learning target information and may also generate candidates for the output information by using these models.

### 4-3. Configuration of Devices

Each of the databases 31 and 32 registered in the storage unit 30 may also be included in an external storage server. Furthermore, the information providing device 10 may also be implemented by operating, in cooperation with each other, a learning server that performs the learning process and an output server that performs the output process. In such a case, any configuration may be used as long as the learning unit 41 illustrated in FIG. 3 is arranged in the learning server, whereas the acquiring unit 42, the estimating unit 43, the selecting unit 44, and the output unit 45 are arranged in the output server.

### 4-4. Others

Of the processes described in the embodiment, the whole or a part of the processes that are mentioned as being automatically performed can also be manually performed, whereas the whole or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

Furthermore, the components of each device illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

Furthermore, each of the embodiments described above can be appropriately used in combination as long as the processes do not conflict with each other.

### 4-5. Program

Furthermore, the information providing device 10 according to the embodiment described above is implemented by a computer 1000 having the configuration illustrated in, for example, FIG. 7. FIG. 7 is a diagram illustrating an example of a hardware configuration. The computer 1000 is connected to an output device 1010 and an input device 1020 and has a configuration in which an arithmetic unit 1030, a primary storage device 1040, a secondary storage device 1050, an output interface (IF) 1060, an input IF 1070, and a network IF 1080 are connected by a bus 1090.

The arithmetic unit 1030 is operated based on the programs stored in the primary storage device 1040 or the secondary storage device 1050 or based on the programs read from the input device 1020 and performs various kinds of processes. The primary storage device 1040 is a memory device, such as a RAM, that primarily stores therein data that is used by the arithmetic unit 1030 to perform various kinds of arithmetic operations. Furthermore, the secondary storage device 1050 is a storage device in which data that is used by the arithmetic unit 1030 to perform various kinds or arithmetic operations and various kinds of database are registered and is implemented by a read only memory (ROM), an HDD, a flash memory, and the like.

The output IF 1060 is an interface for sending information that is targeted for an output with respect to the output device 1010, such as a monitor or a printer, that outputs various kinds of information and is implemented by, for example, the standard connector, such as a universal serial bus (USB), a digital visual interface (DVI), a High Definition Multimedia Interface (registered trademark) (HDMI), or the like. Furthermore, the input IF 1070 is an interface for receiving information from various kinds of the input device 1020, such as a mouse, a keyboard, a scanner, or the like, and is implemented by, for example, an USB, or the like.

Furthermore, the input device 1020 may also be, for example, an optical recording medium, such as a compact disc (CD), a digital versatile disc (DVD), a phase change rewritable disk (PD), or the like; a magneto-optical recording medium, such as a magneto-optical disk (MO), or the like; or a device that reads information from a tape medium, a magnetic recording medium, a semiconductor memory, or the like. Furthermore, the input device 1020 may also be an external storage medium, such as a USB memory, or the like.

The network IF 1080 receives data from another device via the network N and sends the data to the arithmetic unit 1030. Furthermore, the network IF 1080 sends the data created by the arithmetic unit 1030 to the other device via the network N.

The arithmetic unit 1030 controls the output device 1010 and the input device 1020 via the output IF 1060 and the input IF 1070, respectively. For example, the arithmetic unit 1030 loads the program from the input device 1020 or the secondary storage device 1050 into the primary storage device 1040 and executes the loaded program.

For example, if the computer 1000 functions as the information providing device 10, the arithmetic unit 1030 in the computer 1000 implements the function of the control unit 40 by executing the program or data (for example, the model Ml) loaded in the primary storage device 1040. The arithmetic unit 1030 in the computer 1000 reads the program or the data (for example, the model Ml) from the primary storage device 1040 and executes the program or the data; however, as another example, the program may also be acquired from other devices via the network N.

### 5. Effects

As described above, the information providing device 10 acquires a plurality of pieces of output information generated from predetermined target information by a plurality of models each of which generates, from input information, output information that includes a plurality of pieces of information that has an order relation. Then, the information providing device 10 selects, based on the similarity between the plurality of pieces of output information, from among the plurality of pieces of output information, output information that is to be output as association information that is associated with the target information and then outputs, as the association information, the selected output information. As the results of the processes described above, because the information providing device 10 can parallelize the process performed by each of the models performed in ensemble of the output information output by the plurality of models, it is possible to improve the efficiency of generating the output information associated with the input information.

Furthermore, the information providing device 10 selects, based on a semantic similarity between the plurality of pieces of output information, the output information that is to be output as the association information. Furthermore, the information providing device 10 selects, based on the cosine similarity between vectors associated with the plurality of pieces of output information, the output information that is to be output as the association information. For example, the information providing device 10 generates a vector by integrating the vectors associated with the plurality of pieces of information included in the output information as the vector that is associated with the subject output information and then selects, based on the cosine similarity between the generated vectors, the output information to be output as the association information. Furthermore, the information providing device 10 selects, from among the plurality of pieces of output information, the output information in which the similarity with the other piece of output information is high. Consequently, the information providing device 10 can output, from the output information individually generated by each of the models, the output information that is most likely to be appropriate as the association information that is associated with the input information.

Furthermore, the information providing device 10 estimates, based on the similarity between the output information, a probability distribution of the output information that is likely to be generated from the predetermined target information and selects, from among the plurality of pieces of output information, the output information that is included in a predetermined area in the probability distribution. For example, by using kernel density estimation in which the pieces of output information generated by the plurality of models are regarded as samples, the information providing device 10 estimates the probability distribution of the output information that is likely to be generated from the predetermined target information. Then, the information providing device 10 selects, in the probability distribution, the output information that is included in an area in which a larger number of pieces of output information is likely to be included. Consequently, the information providing device 10 can output, from the output information individually generated by each of the models, the output information that is most likely to be appropriate as the association information that is associated with the input information.

Furthermore, the information providing device 10 acquires, when the information that has been output as the model is input, the output information that has been generated by a recurrent neural network that outputs new information. For example, the information providing device 10 acquires output information that has been generated by a plurality of models that is generated from a plurality of models in each of which a connection coefficient between nodes is randomly different and that is allowed to learn the feature held by each of the pieces of learning information.

For example, the information providing device 10 acquires output information generated by a plurality of models that is generated from an identical model and that is allowed to individually learn the feature held by the learning information to different stages. Furthermore, as another example, the information providing device 10 acquires the output information generated by a plurality of models each having a different connection relation between nodes. Furthermore, as another example, the information providing device 10 acquires output information generated by a plurality of models that has learned the feature of different pieces of learning target information and that has learned the feature of a plurality of pieces of learning target information generated from predetermined learning information.

Furthermore, the information providing device 10 acquires a plurality of pieces of output information generated from predetermined target information by a plurality of models each of which includes an encoder that generates, when input information including a plurality of pieces of information is input as a model, feature information indicating the feature held by the subject input information and a decoder that sequentially generates a plurality of pieces of information included in the output information from the feature information that has been generated by the encoder. Consequently, the information providing device 10 can improve the accuracy of generating association information that is associated with the input information including, for example, continuous information and that includes continuous information.

Furthermore, the information providing device 10 acquires the plurality of pieces of output information generated, from target information that is a text, by the plurality of models each of which generates output information that is a text from input information that is a text. For example, the information providing device 10 acquires the plurality of pieces of output information generated, from target information that is a text, by a plurality of models each of which generates output information that is a text corresponding to a heading or a summary of the text from the input information that is the text. Consequently, the information providing device 10 can improve the accuracy of, for example, the heading generated from an input sentence.

In the above, embodiments of the present invention have been described in detail based on the drawings; however the embodiments are described only by way of an example. In addition to the embodiments described in disclosure of invention, the present invention can be implemented in a mode in which various modifications and changes are made in accordance with the knowledge of those skilled in the art.

Furthermore, the “components (sections, modules, units)” described above can be read as “means”, “circuits”, or the like. For example, the detecting unit can be read as a detecting means or a detecting circuit.

According to an aspect of an embodiment, it is possible to improve the efficiency of generating output information that is associated with input information.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An output device comprising:
an acquiring unit that acquires a plurality of pieces of output information generated from predetermined target information by a plurality of models each of which generates, from input information, output information that includes a plurality of pieces of information having an order relation;
a selecting unit that selects, based on a similarity between the plurality of pieces of output information, from among the plurality of pieces of output information, output information that is to be output as association information associated with the target information; and
an output unit that outputs, as the association information, the output information selected by the selecting unit.

2. The output device according to claim 1, wherein the selecting unit selects, based on a semantic similarity between the plurality of pieces of output information, the output information that is to be output as the association information.

3. The output device according to claim 1, wherein the selecting unit selects, based on cosine similarity between vectors associated with the plurality of pieces of output information, the output information that is to be output as the association information.

4. The output device according to claim 3, wherein the selecting unit generates a vector, for every output information, by integrating the vectors associated with the plurality of pieces of information included in the output information as the vector that is associated with the output information and selects the output information that is to be output as the association information based on the cosine similarity between the generated vectors.

5. The output device according to claim 1, wherein the selecting unit selects, from among the plurality of pieces of output information, output information in which the similarity with another piece of output information is high.

6. The output device according to claim 1, further comprising an estimating unit that estimates, based on the similarity between the pieces of output information, a probability distribution of the output information that is likely to be generated from the predetermined target information, wherein
the selecting unit selects, from among the plurality of pieces of output information, the output information included in a predetermined area in the probability distribution.

7. The output device according to claim 6, wherein the estimating unit estimates, based on kernel density estimation in which the pieces of output information generated by the plurality of models are regarded as samples, the probability distribution of the output information that is likely to be generated from the predetermined target information.

8. The output device according to claim 6, wherein the selecting unit selects, in the probability distribution, the output information included in an area in which a larger number of pieces of output information are included.

9. The output device according to claim 1, wherein the acquiring unit acquires the output information generated by a recurrent neural network, the recurrent neural network generates the output information different from information which is input to the recurrent neural network.

10. The output device according to claim 9, wherein the acquiring unit acquires the output information generated by a plurality of models that is generated from a plurality of models in each of which a connection coefficient between nodes is randomly different and that is allowed to learn the feature that is individually held by learning information.

11. The output device according to claim 9, wherein the acquiring unit acquires the output information generated by the plurality of models that is generated from an identical model and that is allowed to individually learn the feature held by the learning information to different stages.

12. The output device according to claim 9, wherein the acquiring unit acquires the output information generated by a plurality of models each having a different connection relation between nodes.

13. The output device according to claim 9, wherein the acquiring unit acquires the output information generated by a plurality of models each of which has learned the feature of different pieces of learning target information and that has learned the feature of a plurality of pieces of learning target information generated from predetermined learning information.

14. The output device according to any one of claim 1, wherein the acquiring unit acquires a plurality of pieces of output information generated from predetermined target information by a plurality of models each of which includes an encoder that generates, when input information including a plurality of pieces of information is input, feature information indicating the feature held by the input information and a decoder that sequentially generates a plurality of pieces of information included in the output information from the feature information that has been generated by the encoder.

15. The output device according to claim 1, wherein the acquiring unit acquires the plurality of pieces of output information generated, from the target information that is a text, by the plurality of models each of which generates the output information that is a text from the input information that is a text.

16. The output device according to claim 15, wherein the acquiring unit acquires the plurality of pieces of output information generated, from the target information that is the text, by the plurality of models each of which generates the output information that is a text corresponding to a heading or a summary of the text from the input information that is the text.

17. An output method performed by an output device, the output method comprising:
acquiring a plurality of pieces of output information generated from predetermined target information by a plurality of models each of which generates, from input information, output information that includes a plurality of pieces of information having an order relation;
selecting, based on a similarity between the plurality of pieces of output information, from among the plurality of pieces of output information, output information that is to be output as association information associated with the target information; and
outputting, as the association information, the output information selected at the outputting.

18. A non-transitory computer-readable storage medium having stored therein a program that causes a computer to execute as a model comprising:
acquiring a plurality of pieces of output information generated from predetermined target information by a plurality of models each of which generates, from input information, output information that includes a plurality of pieces of information having an order relation;
selecting, based on a similarity between the plurality of pieces of output information, from among the plurality of pieces of output information, output information that is to be output as association information associated with the target information; and
outputting, as the association information, the output information selected at the outputting.
